(19) United States
(12) Patent Application Publication
(10) Pub. No.: US 2024/0372390 A1
(43) Pub. Date: Nov. 7, 2024

(54) POWER SUPPLY AND IMAGE DISPLAY APPARATUS INCLUDING SAME

(71) Applicant: LG ELECTRONICS INC., Seoul (KR)

(72) Inventor: Doosung AN, Seoul (KR)

(73) Assignee: LG ELECTRONICS INC., Seoul (KR)

(21) Appl. No.: 18/647,066

(22) Filed: Apr. 26, 2024

(30) Foreign Application Priority Data
May 4, 2023 (KR) 10-2023-0058416

(51) Int. Cl. H02J 7/00; G09G 3/3233

(52) U.S. Cl. CPC H02J 7/00712; G09G 3/3233; H02J 7/0068; G09G 2300/0842; G09G 2330/021; G09G 2330/026; H02J 2207/20

(57) ABSTRACT

Disclosed are a power supply and an image display apparatus including the same. According to an embodiment of the present disclosure, a power supply includes a converter to convert a level of input voltage and output display driving voltage; a first switch electrically connected to a battery; a driving driver to drive the first switch based on the input voltage; and a second switch connected between the first switch and the converter, and upon a charging mode of the battery, in the case of a stand-by mode in which the display is turned off, the first switch and the second switch are turned on to supply a third current generated by adding a first current which flows through the driving driver and a second current which flows through the converter and the second switch to the battery through the first switch. As a result, the battery can be efficiently charged in the stand-by mode.

### CROSS-REFERENCE TO RELATED APPLICATIONS

Pursuant to 35 U.S.C. § 119 (a), this application claims the benefit of earlier filing date and right of priority to Korean Patent Application No. 10-2023-0058416, filed on May 4, 2023, the contents of which are all hereby incorporated by reference herein in their entireties.

### BACKGROUND

### 1. Field

The present disclosure relates to a power supply and an image display apparatus including the same, and more particularly, to a power supply capable of efficiently charging a battery in a stand-by mode and an image display apparatus including the same.

### 2. Description of the Related Art

A power supply is a device that converts a level of input voltage and outputs the converted voltage.

An image display apparatus is an apparatus that displays an image through a display, and for driving the display, the power supply supplies driving voltage to the display.

Meanwhile, when a battery is adopted in the image display apparatus, various methods are being attempted for rapid charging of the battery.

### SUMMARY

An object of the present disclosure is to provide a power supply capable of efficiently charging a battery in a stand-by mode and an image display apparatus including the same.

An object of the present disclosure is to provide a power supply capable of efficiently charging a battery by using different battery charging paths when a display is on and in response to the display being off and an image display apparatus including the same.

In accordance with an embodiment of the present disclosure, a power supply includes a converter to convert a level of input voltage and output driving voltage of a display, a first switch electrically connected to a battery, a driving driver to drive the first switch based on the input voltage, and a second switch connected between the first switch and the converter, and a third current generated by adding a first current which flows through the driving driver and a second current which flows through the converter and the second switch is supplied to the battery through the first switch as the first switch and the second switch are turned on in a stand-by mode in which the display is turned off upon a charging mode of the battery.

Meanwhile, in response to the display being turned on upon the charging mode of the battery, by turning on the first switch and turning off the second switch, the driving voltage outputted from the converter may be supplied to the display and the first current which flows through the driving driver may be supplied to the battery.

Meanwhile, upon the charging mode of the battery, a charging speed change rate of the battery is preferably greater in the stand-by mode in which the display is turned off than in which the display is turned on.

Meanwhile, in response to the input voltage being supplied and the display being turned on in a state in which the battery is not in the charging mode, the first switch and the second switch are turned off to supply the driving voltage outputted from the converter to the display.

Meanwhile, in the stand-by mode in which the display is turned off, the driving voltage outputted from the converter may not be supplied to the display.

Meanwhile, in response to the display being turned on upon a discharging mode of the battery, by turning on the first switch and the second switch, battery voltage may be supplied to the display through current paths which flow through the first and second switches.

Meanwhile, in the charging mode or a normal mode of the battery, the driving voltage outputted from the converter may be equal to or greater than the battery voltage supplied to the display upon the discharging mode of the battery according to an operation of the converter.

Meanwhile, the converter may not operate upon the discharging mode of the battery.

Meanwhile, the power supply may further include a signal transceiver to receive a display on signal or a display off signal from a main board including a signal processing device or the signal processing device, and transmit the display on signal or the display off signal.

Meanwhile, the converter is configured to operate based on the display on signal from the signal transceiver, supply the driving voltage to the display, and not output the driving voltage based on the display off signal from the signal transceiver.

Meanwhile, in response to the display switching from the on state to the stand-by state upon the charging mode of the battery, the converter may be configured to operate in a static current mode during a first period to supply the third current to the battery through the first switch, and operate in a state voltage mode during a second period after the first period.

Meanwhile, in response to the display being on upon the charging mode of the battery, the converter may be configured to operate in the static current mode during a third period to supply the first current to the battery through the first switch, and operate in the state voltage mode during a fourth period after the third period, and the third period may be longer than the first period.

Meanwhile, in response to the display switching to the stand-by mode in the state in which the display is on upon the charging mode of the battery, a first charging charge rate may be increased to a second charging charge rate greater than the first charging charge rate with respect to the charging rate from the battery.

Meanwhile, the power supply may further include a second converter to convert the level of the input voltage and output micom driving voltage at a lower level than the display driving voltage.

Meanwhile, the power supply may further include a third switch to supply the input voltage to the converter based on switching.

Meanwhile, the battery may supply operating voltage to the third switch.

In accordance with an embodiment of the present disclosure, an image display apparatus includes a display; and a power supply to supply voltage to the display, and the power supply includes a converter to convert a level of input voltage and output display driving voltage; a first switch electrically connected to a battery; a driving driver to drive the first switch based on the input voltage; and a second switch connected between the first switch and the converter, and upon a charging mode of the battery, in the case of a stand-by mode in which the display is turned off, the first switch and the second switch are turned on to supply a third current generated by adding a first current which flows through the driving driver and a second current which flows through the converter and the second switch to the battery through the first switch.

Meanwhile, according to an embodiment of the present disclosure, the image display apparatus may further include a mainboard including a signal processing device, and the mainboard or the signal processing device may output a display on signal or a display off signal to the power supply.

Meanwhile, the mainboard or the signal processing device may output a driving control signal to a driving driver, and output a switch driving control signal to the second switch.

Meanwhile, the mainboard or the signal processing device may output the switch driving control signal to the third switch.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing an image display apparatus according to an embodiment of the present disclosure;

FIG. 2 is an example of an internal block diagram of the image display apparatus;

FIG. 3 is an example of an internal block diagram of a signal processing device of FIG. 2;

FIG. 4A is a diagram showing a method of controlling a remote controller of FIG. 2:

FIG. 4B is an internal block diagram of the remote controller of FIG. 2;

FIG. 5 is an internal block diagram of a display of FIG. 2;

FIGS. 6A and 6B are diagrams referred to in the description of a panel of FIG. 5;

FIG. 7A to 7D are views illustrating various operation modes of the image display apparatus of FIG. 1;

FIG. 8A is a view illustrating a power supply related to the present disclosure;

FIG. 8B is a view referred to for an operation description of FIG. 8A;

FIG. 9 illustrates one example of an internal circuit diagram of a power supply according to an embodiment of the present disclosure;

FIGS. 10A to 10E are views referred to for an operation description of FIG. 9;

FIG. 11 illustrates one example of an internal circuit diagram of a power supply according to another embodiment of the present disclosure;

FIG. 12 is a flowchart illustrating an operating method of a power supply according to an embodiment of the present disclosure; and

FIG. 13 is a view referred to for describing FIG. 12.

### DETAILED DESCRIPTION OF THE PREFERRED EMBODIMENTS

Hereinafter, the present disclosure will be described in detail with reference to the accompanying drawings.

Regarding constituent elements used in the following description, suffixes “module” and “unit” are given only in consideration of ease in the preparation of the specification, and do not have or serve as different meanings. Accordingly, the suffixes “module” and “unit” may be used interchangeably.

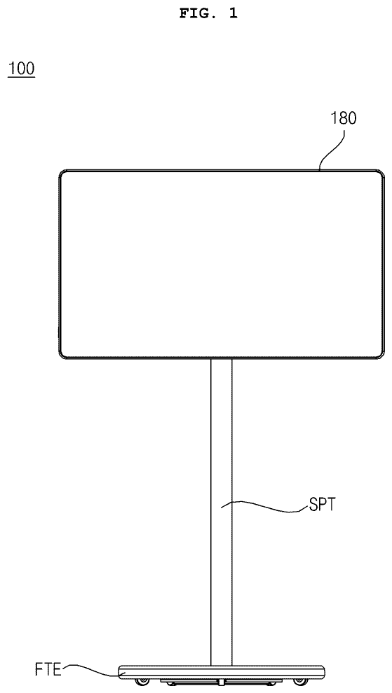

FIG. 1 is a diagram showing an image display apparatus according to an embodiment of the present disclosure.

Referring to FIG. 1, an image display apparatus 100 according to an embodiment of the present disclosure includes a display 180.

Meanwhile, the image display apparatus 100 may further include a base FTE, and a support frame SPT supporting between the base FTE and the display 180.

Meanwhile, the image display apparatus 100 may be a movable image display apparatus.

For example, at least one wheel is disposed below the base FTE to operate when the image display apparatus 100 moves.

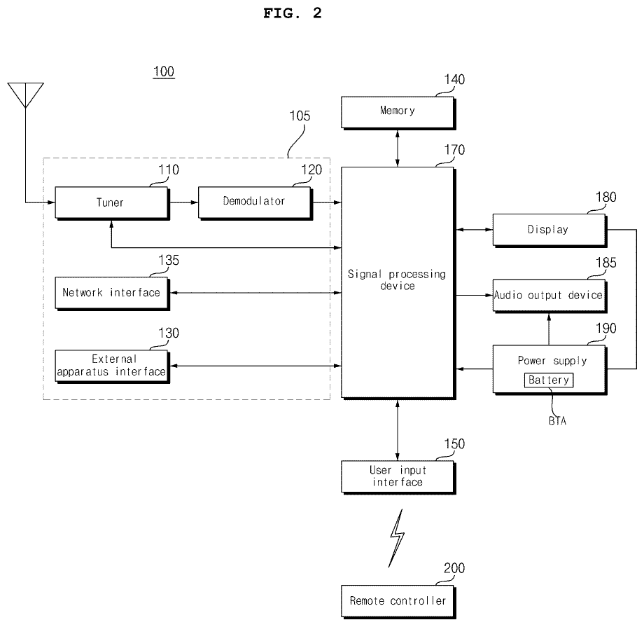

Meanwhile, the image display apparatus 100 according to an embodiment of the present disclosure includes a battery BTA of FIG. 2.

Meanwhile, a power supply 190 of FIG. 2 in the image display apparatus 100 supplies a charging current to the battery BTA to charge the battery BTA upon a charging mode of the battery BTA.

Meanwhile, the power supply 190 according to the embodiment of the present disclosure controls a level of a charging current supplied to the battery BTA when the display 180 is off to be greater than that when the display 180 is on. As a result, the battery BTA can be efficiently charged in a stand-by mode.

Meanwhile, the image display apparatus 100 of FIG. 1 may be a TV, a monitor, a tablet PC, a mobile terminal, etc.

FIG. 2 is an example of an internal block diagram of the image display apparatus of FIG. 1.

Referring to FIG. 2, the image display apparatus 100 according to an embodiment of the present disclosure includes an image receiver 105, an external apparatus interface 130, a memory 140, a user input interface 150, a sensor device (not shown), a signal processing device 170, a display 180, and an audio output device 185.

The image receiver 105 may include a tuner 110, a demodulator 120, a network interface 135, and an external apparatus interface 130.

Meanwhile, unlike the figure, the image receiver 105 may include only the tuner 110, the demodulator 120, and the external apparatus interface 130. That is, the network interface 135 may not be included.

The tuner 110 selects an RF broadcast signal corresponding to a channel selected by a user or all pre-stored channels among radio frequency (RF) broadcast signals received through an antenna (not shown). In addition, the selected RF broadcast signal is converted into an intermediate frequency signal, a baseband image, or an audio signal.

For example, the tuner 110 converts the selected RF broadcasting signal into a digital IF signal (DIF) when the selected RF broadcasting signal is a digital broadcasting signal, and converts the selected RF broadcasting signal into an analog baseband image or voice signal (CVBS/SIF) when the selected RF broadcasting signal is an analog broadcasting signal. That is, the tuner 110 may process the digital broadcasting signal or the analog broadcasting signal. The analog baseband image or voice signal outputted from the tuner 110 may be directly inputted into the signal processing device 170.

Meanwhile, the tuner 110 may include a plurality of tuners for receiving broadcast signals of a plurality of channels. Alternatively, a single tuner that simultaneously receives broadcast signals of a plurality of channels is also available.

The demodulator 120 receives the converted digital IF signal DIF from the tuner 110 and performs a demodulation operation.

The demodulator 120 may perform demodulation and channel decoding and then output a stream signal TS. At this time, the stream signal may be a multiplexed signal of an image signal, an audio signal, or a data signal.

The stream signal output from the demodulator 120 may be input to the signal processing device 170. The signal processing device 170 performs demultiplexing, image/audio signal processing, and the like, and then outputs an image to the display 180 and outputs audio to the audio output device 185.

The external apparatus interface 130 may transmit or receive data with a connected external apparatus (not shown), e.g., a set-top box 50. To this end, the external apparatus interface 130 may include an A/V input and output device (not shown).

The external apparatus interface 130 may be connected in wired or wirelessly to an external apparatus, such as a digital versatile disk (DVD), a Blu ray, a game equipment, a camera, a camcorder, a computer (note book), and a set-top box, and may perform an input/output operation with an external apparatus.

The A/V input and output device may receive image and audio signals from an external apparatus. Meanwhile, a wireless transceiver (not shown) may perform short-range wireless communication with other electronic apparatus.

Through the wireless transceiver (not shown), the external apparatus interface 130 may exchange data with an adjacent mobile terminal 600. In particular, in a mirroring mode, the external apparatus interface 130 may receive device information, executed application information, application image, and the like from the mobile terminal 600.

The network interface 135 provides an interface for connecting the image display apparatus 100 to a wired/wireless network including the Internet network. For example, the network interface 135 may receive, via the network, content or data provided by the Internet, a content provider, or a network operator.

Meanwhile, the network interface 135 may include a wireless transceiver (not shown).

The memory 140 may store a program for each signal processing and control in the signal processing device 170, and may store signal-processed image, audio, or data signal.

In addition, the memory 140 may serve to temporarily store image, audio, or data signal input to the external apparatus interface 130. In addition, the memory 140 may store information on a certain broadcast channel through a channel memory function, such as a channel map.

Although FIG. 2 illustrates that the memory is provided separately from the signal processing device 170, the scope of the present disclosure is not limited thereto. The memory 140 may be included in the signal processing device 170.

The user input interface 150 transmits a signal input by the user to the signal processing device 170 or transmits a signal from the signal processing device 170 to the user.

For example, it may transmit/receive a user input signal, such as power on/off, channel selection, screen setting, etc., from a remote controller 200, may transfer a user input signal input from a local key (not shown), such as a power key, a channel key, a volume key, a set value, etc., to the signal processing device 170, may transfer a user input signal input from a sensor device (not shown) that senses a user's gesture to the signal processing device 170, or may transmit a signal from the signal processing device 170 to the sensor device (not shown).

The signal processing device 170 may demultiplex the input stream through the tuner 110, the demodulator 120, the network interface 135, or the external apparatus interface 130, or process the demultiplexed signals to generate and output a signal for image or audio output.

For example, the signal processing device 170 receives a broadcast signal received by the image receiver 105 or an HDMI signal, and perform signal processing based on the received broadcast signal or the HDMI signal to thereby output a processed image signal.

The image signal processed by the signal processing device 170 is input to the display 180, and may be displayed as an image corresponding to the image signal. In addition, the image signal processed by the signal processing device 170 may be input to the external output apparatus through the external apparatus interface 130.

The audio signal processed by the signal processing device 170 may be output to the audio output device 185 as an audio signal. In addition, audio signal processed by the signal processing device 170 may be input to the external output apparatus through the external apparatus interface 130.

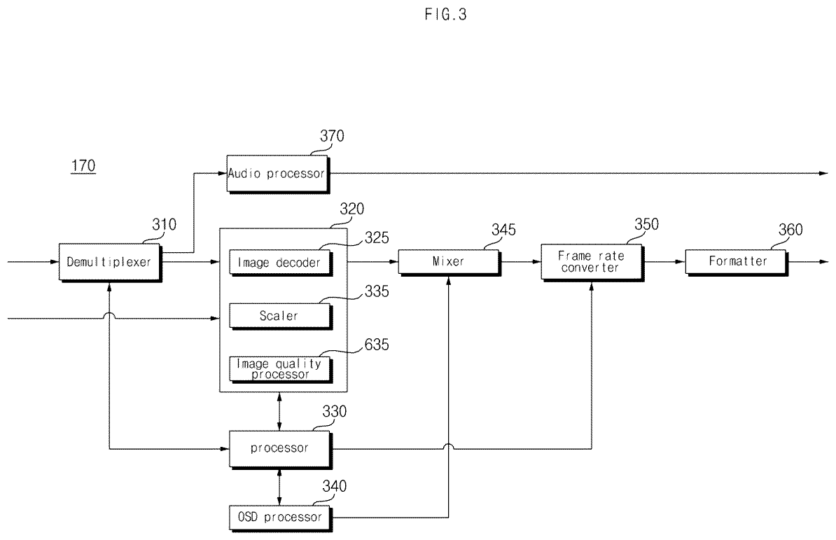

Although not shown in FIG. 2, the signal processing device 170 may include a demultiplexer, an image processor, and the like. That is, the signal processing device 170 may perform a variety of signal processing and thus it may be implemented in the form of a system on chip (SOC). This will be described later with reference to FIG. 3.

In addition, the signal processing device 170 may control the overall operation of the image display apparatus 100. For example, the signal processing device 170 may control the tuner 110 to control the tuning of the RF broadcast corresponding to the channel selected by the user or the previously stored channel.

In addition, the signal processing device 170 may control the image display apparatus 100 according to a user command input through the user input interface 150 or an internal program.

Meanwhile, the signal processing device 170 may control the display 180 to display an image. At this time, the image displayed on the display 180 may be a still image or a moving image, and may be a 2D image or a 3D image.

Meanwhile, the signal processing device 170 may display a certain object in an image displayed on the display 180. For example, the object may be at least one of a connected web screen (newspaper, magazine, etc.), an electronic program guide (EPG), various menus, a widget, an icon, a still image, a moving image, and a text.

Meanwhile, the signal processing device 170 may recognize the position of the user based on the image photographed by a photographing device (not shown). For example, the distance (z-axis coordinate) between a user and the image display apparatus 100 may be determined. In addition, the x-axis coordinate and the y-axis coordinate in the display 180 corresponding to a user position may be determined.

The display 180 generates a driving signal by converting an image signal, a data signal, an OSD signal, a control signal processed by the signal processing device 170, an image signal, a data signal, a control signal, and the like received from the external apparatus interface 130.

Meanwhile, the display 180 may be configured as a touch screen and used as an input device in addition to an output device.

The audio output device 185 receives a signal processed by the signal processing device 170 and outputs it as an audio.

The photographing device (not shown) photographs a user. The photographing device (not shown) may be implemented by a single camera, but the present disclosure is not limited thereto and may be implemented by a plurality of cameras. Image information photographed by the photographing device (not shown) may be input to the signal processing device 170.

The signal processing device 170 may sense a gesture of the user based on each of the images photographed by the photographing device (not shown), the signals detected from the sensor device (not shown), or a combination thereof.

The power supply 190 supplies corresponding power to the image display apparatus 100.

Particularly, the power may be supplied to a signal processing device 170 which may be implemented in the form of a system on chip (SOC), a display 180 for displaying an image, and an audio output device 185 for outputting an audio.

Specifically, the power supply 190 may include a converter to convert the level of the input voltage.

For example, the power supply 190 may include an ac/dc converter and a dc/dc converter when the input voltage is an alternating current voltage.

As another example, the power supply 190 may include the dc/dc converter when the input voltage is a direct current voltage.

Meanwhile, the power supply 190 includes the battery BTA.

The remote controller 200 transmits the user input to the user input interface 150. To this end, the remote controller 200 may use Bluetooth, a radio frequency (RF) communication, an infrared (IR) communication, an Ultra Wideband (UWB), ZigBee, or the like. In addition, the remote controller 200 may receive the image, audio, or data signal output from the user input interface 150, and display it on the remote controller 200 or output it as an audio.

Meanwhile, the image display apparatus 100 may be a fixed or mobile digital broadcast receiver capable of receiving digital broadcast.

Meanwhile, a block diagram of the image display apparatus 100 shown in FIG. 2 is a block diagram for an embodiment of the present disclosure. Each component of the block diagram may be integrated, added, or omitted according to a specification of the image display apparatus 100 actually implemented. That is, two or more components may be combined into a single component as needed, or a single component may be split into two or more components. The function performed in each block is described for the purpose of illustrating embodiments of the present disclosure, and specific operation and apparatus do not limit the scope of the present disclosure.

FIG. 3 is an example of an internal block diagram of the signal processing device in FIG. 2.

Referring to the figure, the signal processing device 170 according to an embodiment of the present disclosure may include a demultiplexer 310, an image processor 320, a processor 330, and an audio processor 370. In addition, the signal processing device 170 may further include and a data processor (not shown).

The demultiplexer 310 demultiplexes the input stream. For example, when an MPEG-2 TS is input, it may be demultiplexed into image, audio, and data signal, respectively. Here, the stream signal input to the demultiplexer 310 may be a stream signal output from the tuner 110, the demodulator 120, or the external apparatus interface 130.

The image processor 320 may perform signal processing on an input image. For example, the image processor 320 may perform image processing on an image signal demultiplexed by the demultiplexer 310.

To this end, the image processor 320 may include an image decoder 325, a scaler 335, an image quality processor 635, an image encoder (not shown), an OSD processor 340, a frame rate converter 350, a formatter 360, etc.

The image decoder 325 decodes a demultiplexed image signal, and the scaler 335 performs scaling so that the resolution of the decoded image signal may be output from the display 180.

The image decoder 325 may include a decoder of various standards. For example, a 3D image decoder for MPEG-2, H.264 decoder, a color image, and a depth image, and a decoder for a multiple view image may be provided.

The scaler 335 may scale an input image signal decoded by the image decoder 325 or the like.

For example, if the size or resolution of an input image signal is small, the scaler 335 may upscale the input image signal, and, if the size or resolution of the input image signal is great, the scaler 335 may downscale the input image signal.

The image quality processor 635 may perform image quality processing on an input image signal decoded by the image decoder 325 or the like.

For example, the image quality processor 625 may perform noise reduction processing on an input image signal, extend a resolution of high gray level of the input image signal, perform image resolution enhancement, perform high dynamic range (HDR)-based signal processing, change a frame rate, perform image quality processing suitable for properties of a panel, especially an OLED panel, etc.

The OSD processor 340 generates an OSD signal according to a user input or by itself. For example, based on a user input signal, the OSD processor 340 may generate a signal for displaying various information as a graphic or a text on the screen of the display 180. The generated OSD signal may include various data, such as a user interface screen of the image display apparatus 100, various menu screens, a widget, and an icon. In addition, the generated OSD signal may include a 2D object or a 3D object.

In addition, the OSD processor 340 may generate a pointer that may be displayed on the display, based on a pointing signal input from the remote controller 200. In particular, such a pointer may be generated by a pointing signal processing device, and the OSD processor 340 may include such a pointing signal processing device (not shown). Obviously, the pointing signal processing device (not shown) may be provided separately from the OSD processor 340.

The frame rate converter (FRC) 350 may convert a frame rate of an input image. Meanwhile, the frame rate converter 350 may output the input image without converting the frame rate.

Meanwhile, the formatter 360 may change a format of an input image signal into a format suitable for displaying the image signal on a display and output the image signal in the changed format.

In particular, the formatter 360 may change a format of an image signal to correspond to a display panel.

Meanwhile, the formatter 360 may also change the format of the video signal.

The processor 330 may control overall operations of the image display apparatus 100 or the signal processing device 170.

For example, the processor 330 may control the tuner 110 to control the tuning of an RF broadcast corresponding to a channel selected by a user or a previously stored channel.

In addition, the processor 330 may control the image display apparatus 100 according to a user command input through the user input interface 150 or an internal program.

In addition, the processor 330 may transmit data to the network interface 135 or to the external apparatus interface 130.

In addition, the processor 330 may control the demultiplexer 310, the image processor 320, and the like in the signal processing device 170.

Meanwhile, the audio processor 370 in the signal processing device 170 may perform the audio processing of the demultiplexed audio signal. To this end, the audio processor 370 may include various decoders.

In addition, the audio processor 370 in the signal processing device 170 may process a base, a treble, a volume control, and the like.

The data processor (not shown) in the signal processing device 170 may perform data processing of the demultiplexed data signal. For example, when the demultiplexed data signal is a coded data signal, it may be decoded. The encoded data signal may be electronic program guide information including broadcast information, such as a start time and an end time of a broadcast program broadcasted on each channel.

Meanwhile, a block diagram of the signal processing device 170 shown in FIG. 3 is a block diagram for an embodiment of the present disclosure. Each component of the block diagram may be integrated, added, or omitted according to a specification of the signal processing device 170 actually implemented.

In particular, the frame rate converter 350 and the formatter 360 may be provided separately in addition to the image processor 320.

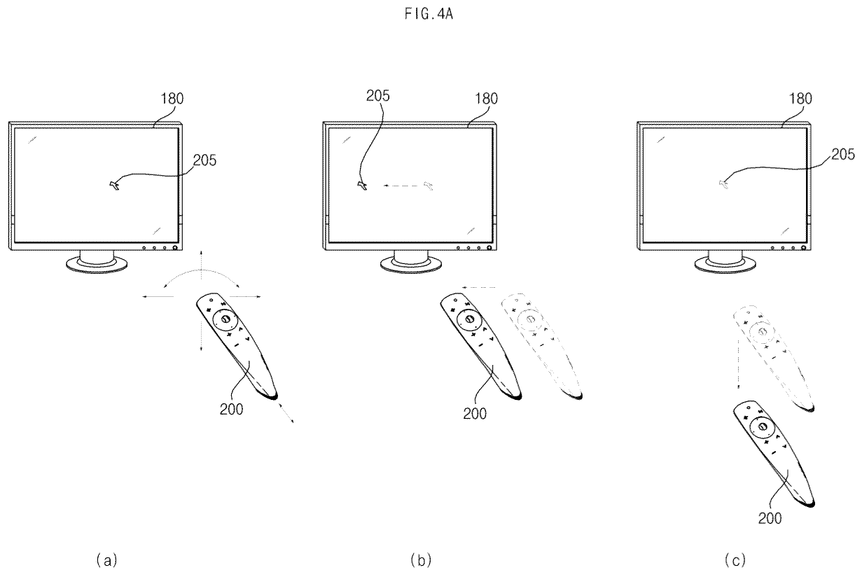

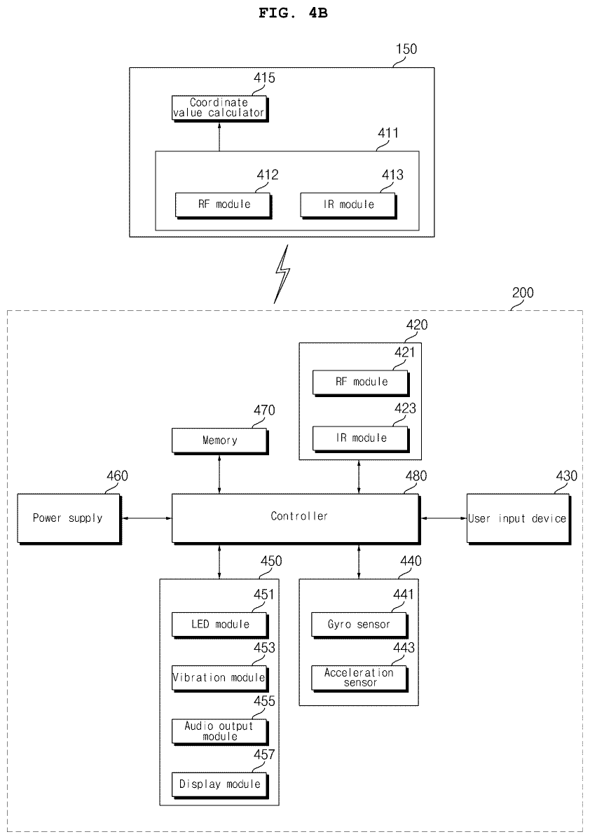

FIG. 4A is a diagram illustrating a control method of a remote controller of FIG. 2.

As shown in FIG. 4A(a), it is illustrated that a pointer 205 corresponding to the remote controller 200 is displayed on the display 180.

The user may move or rotate the remote controller 200 up and down, left and right (FIG. 4A(b)), and back and forth (FIG. 4A(c)). The pointer 205 displayed on the display 180 of the image display apparatus corresponds to the motion of the remote controller 200. Such a remote controller 200 may be referred to as a space remote controller or a 3D pointing apparatus, because the pointer 205 is moved and displayed according to the movement in a 3D space, as shown in the figure.

FIG. 4A(b) illustrates that when the user moves the remote controller 200 to the left, the pointer 205 displayed on the display 180 of the image display apparatus also moves to the left correspondingly.

Information on the motion of the remote controller 200 detected through a sensor of the remote controller 200 is transmitted to the image display apparatus. The image display apparatus may calculate the coordinate of the pointer 205 from the information on the motion of the remote controller 200. The image display apparatus may display the pointer 205 to correspond to the calculated coordinate.

FIG. 4A(c) illustrates a case where the user moves the remote controller 200 away from the display 180, while pressing a specific button of the remote controller 200. Thus, a selection area within the display 180 corresponding to the pointer 205 may be zoomed in so that it may be displayed to be enlarged. Meanwhile, when the user moves the remote controller 200 close to the display 180, the selection area within the display 180 corresponding to the pointer 205 may be zoomed out so that it may be displayed to be reduced. Meanwhile, when the remote controller 200 moves away from the display 180, the selection area may be zoomed out, and when the remote controller 200 approaches the display 180, the selection area may be zoomed in.

Meanwhile, when the specific button of the remote controller 200 is pressed, it is possible to exclude the recognition of vertical and lateral movement. That is, when the remote controller 200 moves away from or approaches the display 180, the up, down, left, and right movements are not recognized, and only the forward and backward movements are recognized. Only the pointer 205 is moved according to the up, down, left, and right movements of the remote controller 200 in a state where the specific button of the remote controller 200 is not pressed.

Meanwhile, the moving speed or the moving direction of the pointer 205 may correspond to the moving speed or the moving direction of the remote controller 200.

FIG. 4B is an internal block diagram of the remote controller of FIG. 2.

Referring to the figure, the remote controller 200 includes a wireless transceiver 425, a user input device 435, a sensor device 440, an output device 450, a power supply 460, a memory 470, and a controller 480.

The wireless transceiver 425 transmits/receives a signal to/from any one of the image display apparatuses according to the embodiments of the present disclosure described above. Among the image display apparatuses according to the embodiments of the present disclosure, one image display apparatus 100 will be described as an example.

In the present embodiment, the remote controller 200 may include an RF module 421 for transmitting and receiving signals to and from the image display apparatus 100 according to a RF communication standard. In addition, the remote controller 200 may include an IR module 423 for transmitting and receiving signals to and from the image display apparatus 100 according to a IR communication standard.

In the present embodiment, the remote controller 200 transmits a signal containing information on the motion of the remote controller 200 to the image display apparatus 100 through the RF module 421.

In addition, the remote controller 200 may receive the signal transmitted by the image display apparatus 100 through the RF module 421. In addition, if necessary, the remote controller 200 may transmit a command related to power on/off, channel change, volume change, and the like to the image display apparatus 100 through the IR module 423.

The user input device 435 may be implemented by a keypad, a button, a touch pad, a touch screen, or the like. The user may operate the user input device 435 to input a command related to the image display apparatus 100 to the remote controller 200. When the user input device 435 includes a hard key button, the user may input a command related to the image display apparatus 100 to the remote controller 200 through a push operation of the hard key button. When the user input device 435 includes a touch screen, the user may touch a soft key of the touch screen to input the command related to the image display apparatus 100 to the remote controller 200. In addition, the user input device 435 may include various types of input means, such as a scroll key, a jog key, etc., which may be operated by the user, and the present disclosure does not limit the scope of the present disclosure.

The sensor device 440 may include a gyro sensor 441 or an acceleration sensor 443. The gyro sensor 441 may sense information regarding the motion of the remote controller 200.

For example, the gyro sensor 441 may sense information on the operation of the remote controller 200 based on the x, y, and z axes. The acceleration sensor 443 may sense information on the moving speed of the remote controller 200. Meanwhile, a distance measuring sensor may be further provided, and thus, the distance to the display 180 may be sensed.

The output device 450 may output an image or an audio signal corresponding to the operation of the user input device 435 or a signal transmitted from the image display apparatus 100. Through the output device 450, the user may recognize whether the user input device 435 is operated or whether the image display apparatus 100 is controlled.

For example, the output device 450 may include an LED module 451 that is turned on when the user input device 435 is operated or a signal is transmitted/received to/from the image display apparatus 100 through the wireless transceiver 425, a vibration module 453 for generating a vibration, an audio output module 455 for outputting an audio, or a display module 457 for outputting an image.

The power supply 460 supplies power to the remote controller 200. When the remote controller 200 is not moved for a certain time, the power supply 460 may stop the supply of power to reduce a power waste. The power supply 460 may resume power supply when a certain key provided in the remote controller 200 is operated.

The memory 470 may store various types of programs, application data, and the like necessary for the control or operation of the remote controller 200. If the remote controller 200 wirelessly transmits and receives a signal to/from the image display apparatus 100 through the RF module 421, the remote controller 200 and the image display apparatus 100 transmit and receive a signal through a certain frequency band. The controller 480 of the remote controller 200 may store information regarding a frequency band or the like for wirelessly transmitting and receiving a signal to/from the image display apparatus 100 paired with the remote controller 200 in the memory 470 and may refer to the stored information.

The controller 480 controls various matters related to the control of the remote controller 200. The controller 480 may transmit a signal corresponding to a certain key operation of the user input device 435 or a signal corresponding to the motion of the remote controller 200 sensed by the sensor device 440 to the image display apparatus 100 through the wireless transceiver 425.

The user input interface 150 of the image display apparatus 100 includes a wireless transceiver 151 that may wirelessly transmit and receive a signal to and from the remote controller 200 and a coordinate value calculator 415 that may calculate the coordinate value of a pointer corresponding to the operation of the remote controller 200.

The user input interface 150 may wirelessly transmit and receive a signal to and from the remote controller 200 through the RF module 412. In addition, the user input interface 150 may receive a signal transmitted by the remote controller 200 through the IR module 413 according to a IR communication standard.

The coordinate value calculator 415 may correct a hand shake or an error from a signal corresponding to the operation of the remote controller 200 received through the wireless transceiver 151 and calculate the coordinate value (x, y) of the pointer 205 to be displayed on the display 180.

The transmission signal of the remote controller 200 inputted to the image display apparatus 100 through the user input interface 150 is transmitted to the controller 180 of the image display apparatus 100. The controller 180 may determine the information on the operation of the remote controller 200 and the key operation from the signal transmitted from the remote controller 200, and, correspondingly, control the image display apparatus 100.

For another example, the remote controller 200 may calculate the pointer coordinate value corresponding to the operation and output it to the user input interface 150 of the image display apparatus 100. In this case, the user input interface 150 of the image display apparatus 100 may transmit information on the received pointer coordinate value to the controller 180 without a separate correction process of hand shake or error.

For another example, unlike the figure, the coordinate value calculator 415 may be provided in the signal processing device 170, not in the user input interface 150.

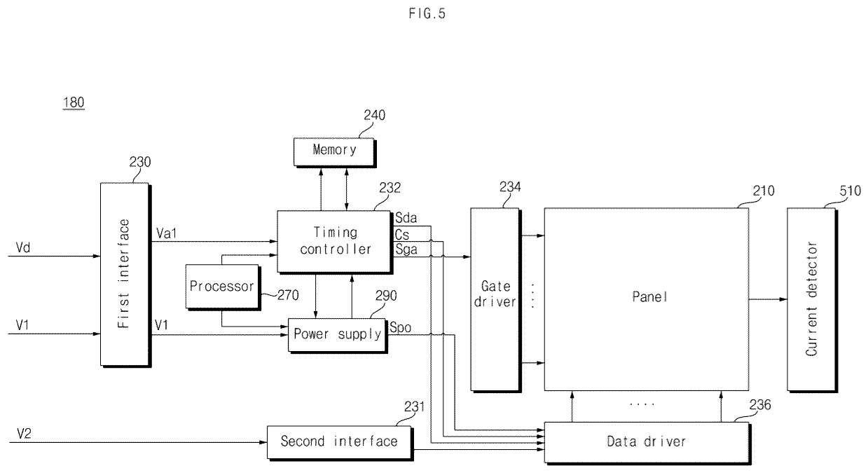

FIG. 5 is an internal block diagram of a display of FIG. 2.

Referring to FIG. 5, the display 180 may include a panel 210, a first interface 230, a second interface 231, a timing controller 232, a gate driver 234, a data driver 236, a memory 240, a processor 270, a power supply 290, a current detector 510, and the like.

The display 180 receives an image signal Vd, a first DC voltage V1, and a second DC voltage V2, and may display a certain image based on the image signal Vd.

Meanwhile, the first interface 230 in the display 180 may receive the image signal Vd and the first DC voltage V1 from the signal processing device 170.

Here, the first DC voltage V1 may be used for the operation of the power supply 290 and the timing controller 232 in the display 180.

Next, the second interface 231 may receive a second DC voltage V2 from an external power supply 190. Meanwhile, the second DC voltage V2 may be input to the data driver 236 in the display 180.

The timing controller 232 may output a data driving signal Sda and a gate driving signal Sga, based on the image signal Vd.

For example, when the first interface 230 converts the input image signal Vd and outputs the converted image signal val, the timing controller 232 may output the data driving signal Sda and the gate driving signal Sga based on the converted image signal val.

The timing controller 232 may further receive a control signal, a vertical synchronization signal Vsync, and the like, in addition to the image signal Vd from the signal processing device 170.

In addition to the image signal Vd, based on a control signal, a vertical synchronization signal Vsync, and the like, the timing controller 232 generates a gate driving signal Sga for the operation of the gate driver 234, and outputs a data driving signal Sda for the operation of the data driver 236.

At this time, when the panel 210 includes a RGBW subpixel, the data driving signal Sda may be a data driving signal for driving of RGBW subpixel.

Meanwhile, when the panel 210 includes an RGB subpixel, the data driving signal Sda may be a data driving signal for driving an RGB subpixel.

Meanwhile, the timing controller 232 may further output a control signal Cs to the gate driver 234.

The gate driver 234 and the data driver 236 supply a scan signal and an image signal to the panel 210 through a gate line GL and a data line DL respectively, according to the gate driving signal Sga and the data driving signal Sda from the timing controller 232. Accordingly, the panel 210 displays a certain image.

Meanwhile, the panel 210 may include an organic light emitting layer. In order to display an image, a plurality of gate lines GL and data lines DL may be disposed in a matrix form in each pixel corresponding to the organic light emitting layer.

Meanwhile, the data driver 236 may output a data signal to the panel 210 based on a second DC voltage V2 from the second interface 231.

The power supply 290 may supply various power supplies to the gate driver 234, the data driver 236, the timing controller 232, and the like.

The current detector 510 may detect the current flowing in a sub-pixel of the panel 210. The detected current may be input to the processor 270 or the like, for a cumulative current calculation.

The processor 270 may perform each type of control of the display 180. For example, the processor 270 may control the gate driver 234, the data driver 236, the timing controller 232, and the like.

Meanwhile, the processor 270 may receive current information flowing in a sub-pixel of the panel 210 from the current detector 510.

In addition, the processor 270 may calculate the accumulated current of each subpixel of the panel 210, based on information of current flowing through the subpixel of the panel 210. The calculated accumulated current may be stored in the memory 240.

Meanwhile, the processor 270 may determine as burn-in, if the accumulated current of each sub-pixel of the panel 210 is equal to or greater than an allowable value.

For example, if the accumulated current of each subpixel of the OLED panel 210 is equal to or greater than 300000 A, the processor 270 may determine that a corresponding subpixel is a burn-in subpixel.

Meanwhile, if the accumulated current of each subpixel of the OLED panel 210 is close to an allowable value, the processor 270 may determine that a corresponding subpixel is a subpixel expected to be burn in.

Meanwhile, based on a current detected by the current detector 510, the processor 270 may determine that a subpixel having the greatest accumulated current is an expected burn-in subpixel.

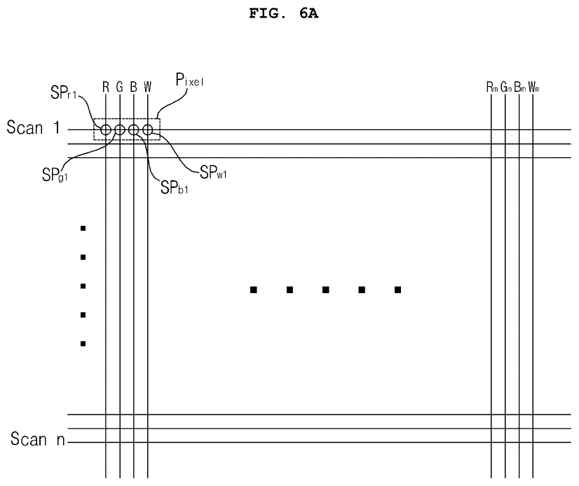

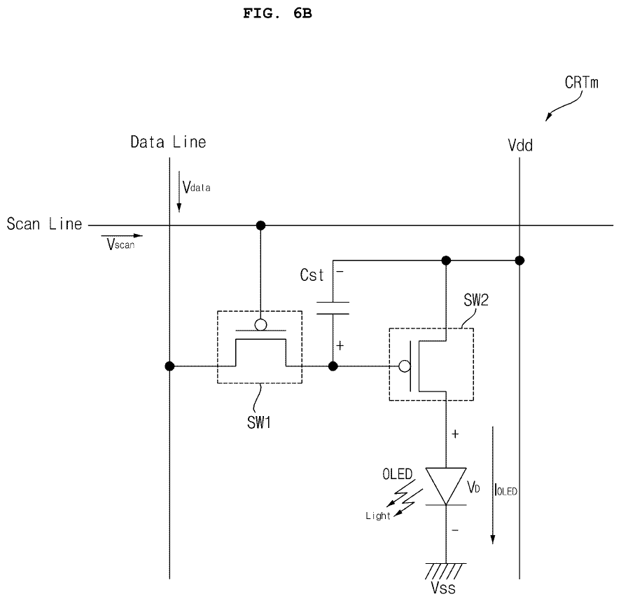

FIG. 6A and FIG. 6B are diagrams referred to in the description of a panel of FIG. 5.

Firstly, FIG. 6A is a diagram illustrating a pixel in the panel 210.

Referring to the figure, the panel 210 may include a plurality of scan lines Scan1 to Scann and a plurality of data lines R1, G1, B1, W1 to Rm, Gm, Bm, Wm intersecting the scan lines.

Meanwhile, a pixel (subpixel) is defined in an intersecting area of the scan line and the data line in the panel 210. In the figure, a pixel including sub-pixels SR1, SG1, SB1 and SW1 of RGBW is shown.

FIG. 6B illustrates a circuit of any one sub-pixel in the pixel of the panel of FIG. 6A.

Referring to the figure, a sub pixel circuit (CRTm) may include, as an active type, a scan switching element SW1, a storage capacitor Cst, a drive switching element SW2, and an organic light emitting layer (OLED).

The scan switching element SW1 is turned on according to the input scan signal Vdscan, as a scan line is connected to a gate terminal. When it is turned on, the input data signal Vdata is transferred to the gate terminal of a drive switching element SW2 or one end of the storage capacitor Cst.

The storage capacitor Cst is formed between the gate terminal and the source terminal of the drive switching element SW2, and stores a certain difference between a data signal level transmitted to one end of the storage capacitor Cst and a DC voltage (VDD) level transmitted to the other terminal of the storage capacitor Cst.

For example, when the data signal has a different level according to a Plume Amplitude Modulation (PAM) method, the power level stored in the storage capacitor Cst varies according to the level difference of the data signal Vdata.

For another example, when the data signal has a different pulse width according to a pulse width modulation (PWM) method, the power level stored in the storage capacitor Cst varies according to the pulse width difference of the data signal Vdata.

The drive switching element SW2 is turned on according to the power level stored in the storage capacitor Cst. When the drive switching element SW2 is turned on, the driving current (IOLED), which is proportional to the stored power level, flows in the organic light emitting layer (OLED). Accordingly, the organic light emitting layer OLED performs a light emitting operation.

The organic light emitting layer OLED may include a light emitting layer (EML) of RGBW corresponding to a subpixel, and may include at least one of a hole injecting layer (HIL), a hole transporting layer (HTL), an electron transporting layer (ETL), and an electron injecting layer (EIL). In addition, it may include a hole blocking layer, and the like.

Meanwhile, the subpixels emit a white light in the organic light emitting layer OLED. However, in the case of green, red, and blue subpixels, a subpixel is provided with a separate color filter for color implementation. That is, in the case of green, red, and blue subpixels, each of the subpixels further includes green, red, and blue color filters. Meanwhile, since a white subpixel outputs a white light, a separate color filter is not required.

Meanwhile, in the figure, it is illustrated that a p-type MOSFET is used for a scan switching element SW1 and a drive switching element SW2, but an n-type MOSFET or other switching element, such as a JFET, IGBT, SIC, or the like are also available.

Meanwhile, the pixel is a hold-type element that continuously emits light in the organic light emitting layer (OLED), after a scan signal is applied, during a unit display period, specifically, during a unit frame.

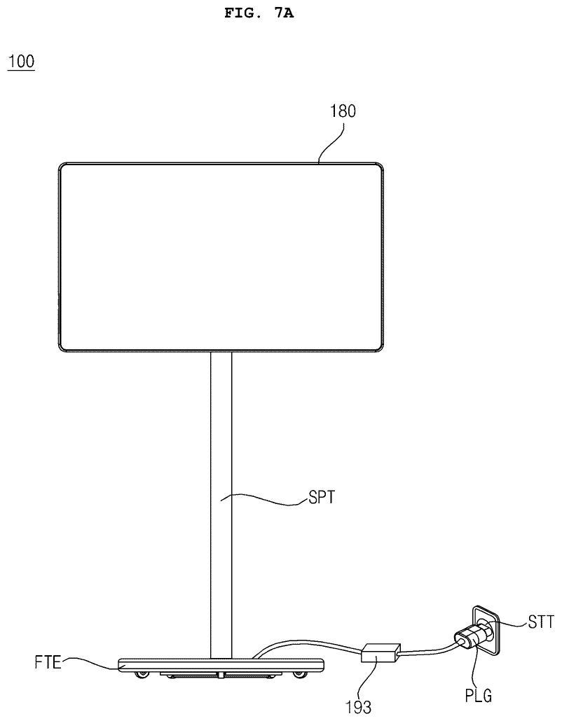

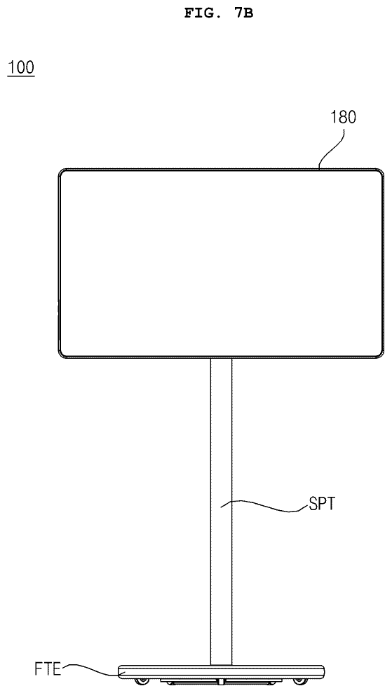

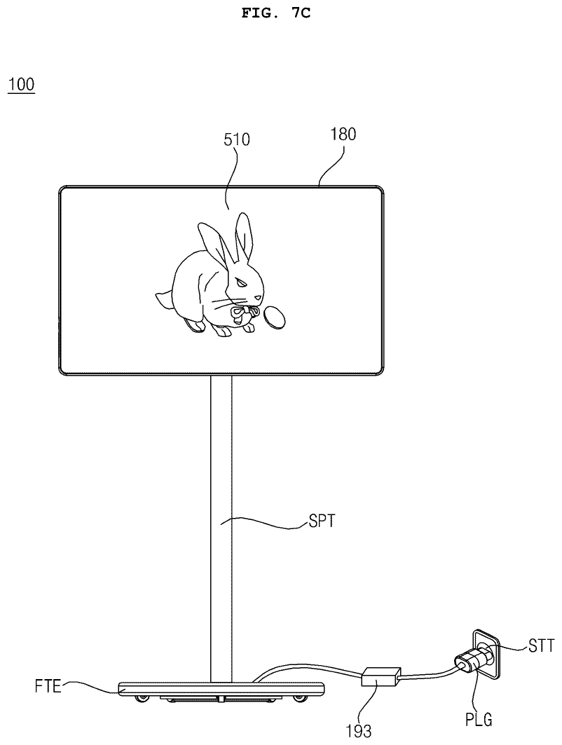

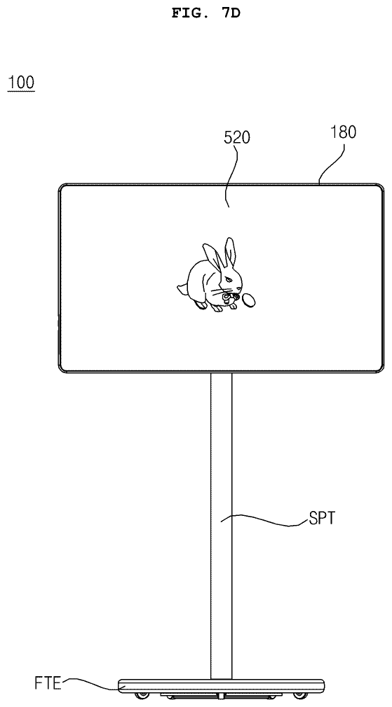

FIG. 7A to 7D are views illustrating various operation modes of the image display apparatus of FIG. 1.

FIG. 7A illustrates a case where the display 180 is off while the input voltage is supplied to the image display apparatus 100.

Referring to FIG. 7A, in the image display apparatus 100, a power plug PLG of a power adapter 193 is connected to a power outlet STT, so the input voltage which is the DC voltage is supplied to the image display apparatus 100.

As a result, the power supply 190 in the image display apparatus 100 operates in a charging mode for charging the battery BTA.

FIG. 7B illustrates a case where the display 180 is off while the input voltage is not supplied to the image display apparatus 100.

Referring to FIG. 7B, in the image display apparatus 100, when the power plug PLG of the power adapter 193 is not connected to the power outlet STT, the input voltage is not supplied to the image display apparatus 100.

FIG. 7C illustrates a case where the display 180 is on while the input voltage is supplied to the image display apparatus 100.

Referring to FIG. 7C, in the image display apparatus 100, the power plug PLG of the power adapter 193 is connected to the power outlet STT, so the input voltage which is the DC voltage is supplied to the image display apparatus 100.

As a result, the power supply 190 in the image display apparatus 100 operates in the charging mode for charging the battery BTA, and simultaneously, supplies the driving voltage to the display 180.

Meanwhile, as the driving voltage is supplied to the display 180, a predetermined image 710 may be displayed in the display 180 as illustrated in FIG. 7C.

FIG. 7D illustrates a case where the display 180 is on while the input voltage is not supplied to the image display apparatus 100.

Referring to FIG. 7D, in the image display apparatus 100, when the power plug PLG of the power adapter 193 is not connected to the power outlet STT, the input voltage is not supplied to the image display apparatus 100.

As a result, the power supply 190 in the image display apparatus 100 operates the battery BTA in the discharging mode to supply the battery voltage to the display 180.

Meanwhile, as the battery voltage is supplied to the display 180, a predetermined image 720 may be displayed in the display 180 as illustrated in FIG. 7D.

As illustrated in FIGS. 7A and 7C, when the input voltage is supplied to the power supply 190 in the image display apparatus 100, the power supply 190 may operate in the charging mode for charging the battery BTA.

Meanwhile, the power supply 190 according to the embodiment of the present disclosure controls a level of a charging current supplied to the battery BTA to be greater than that when the display 180 is on upon the charging mode of the battery BTA to which the input voltage is supplied as illustrated in FIG. 7C in the case of the stand-by mode in which the display 180 is off upon the charging mode of the battery BTA to which the input voltage is supplied as illustrated in FIG. 7A. As a result, the battery BTA can be efficiently charged in the stand-by mode.

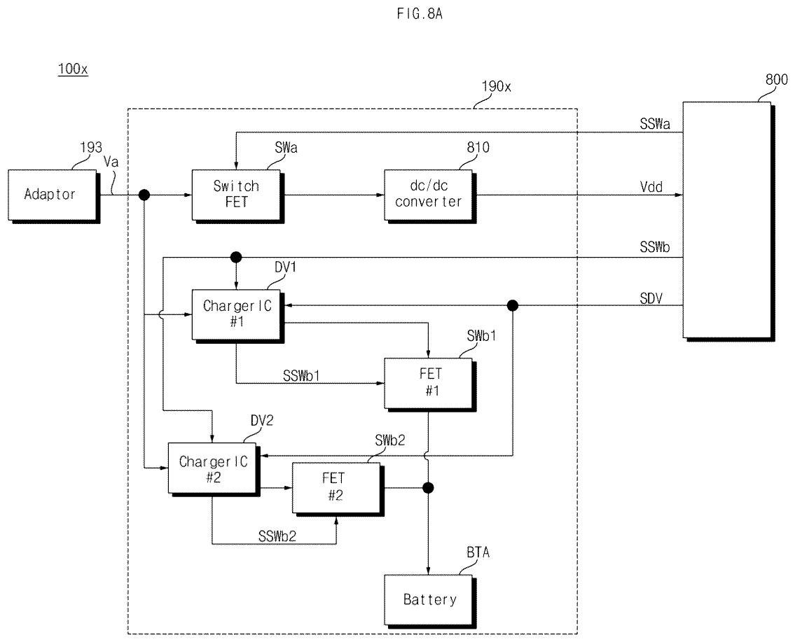

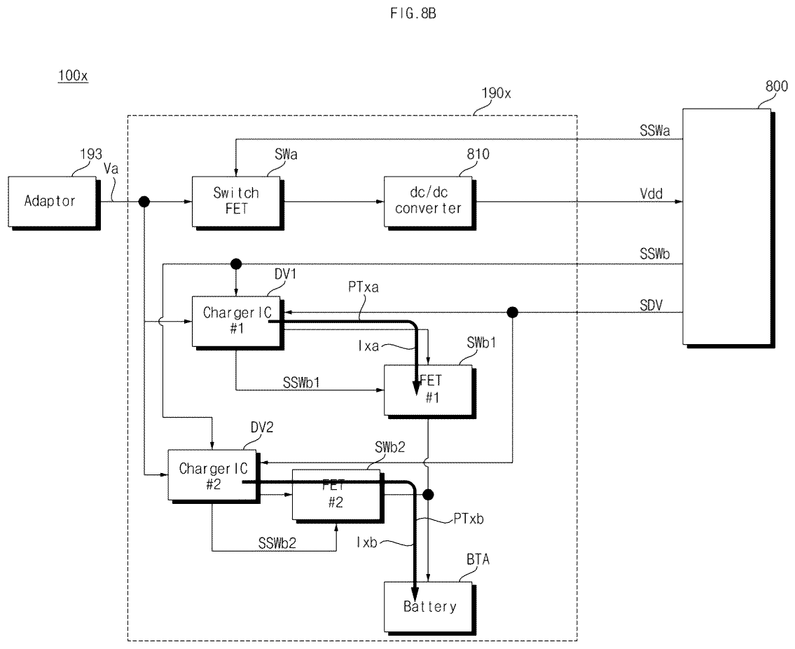

FIG. 8A is a view illustrating a power supply related to the present disclosure.

Referring to FIG. 8A, a power supply 190x related to the present disclosure includes a switch SWa switching and outputting input voltage Va from an adapter 193, a dc/dc converter 810 converting a level of the input voltage Va from the switch SWa, a plurality of charging drivers DV1 and DV2 operating for charging the battery BTA, and a plurality of charging switches SWb1 and SWb2 disposed between the battery BTA and the plurality of charging drivers DV1 and DV2, and switching the charging drivers DV1 and DV2, respectively.

Meanwhile, the power supply 190x may receive, from a mainboard 800, a switch control signal SSWa for controlling the switch SWa, a driver control signal SDV for controlling the plurality of charging drivers DV1 and DV2, and a switch control signal SSWb for controlling the plurality of charging switches SWb1 and SWb2.

FIG. 8B is a view referred to for an operation description of FIG. 8A.

Referring to FIG. 8A, the power supply 190x outputs driving voltage Vdd from the dc/dc converter 810 when the display 180 is on, and based on turn-on of the plurality of charging switches SWb1 and SWb2, a first current Ixa which flows on the first charging switch SWb1 and a second current Ixb which flows on the second charging switch SWb2 are supplied to the battery BTA.

Meanwhile, the power supply 190x does not output the driving voltage Vdd from the dc/dc converter 810 when the display 180 is off, and based on the turn-on of the plurality of charging switches SWb1 and SWb2, the first current Ixa which flows on the first charging switch SWb1 and the second current Ixb which flows on the second charging switch SWb2 are supplied to the battery BTA.

Meanwhile, according to FIGS. 8A and 8B, the battery BTA is charged based on the input voltage Va and the turn-on of the plurality of charging switches SWb1 and SWb2 regardless of the display 180 being on or off.

According to such a scheme, the plurality of charging drivers DV1 and DV2 is required for driving the plurality of charging switches SWb1 and SWb2, and there is a disadvantage in that heat generation is concentrated due to operations of the plurality of charging drivers DV1 and DV2 and the plurality of charging switches SWb1 and SWb2. Further, there is a disadvantage in that efficient charging is not performed by the plurality of charging switches SWb1 and SWb2.

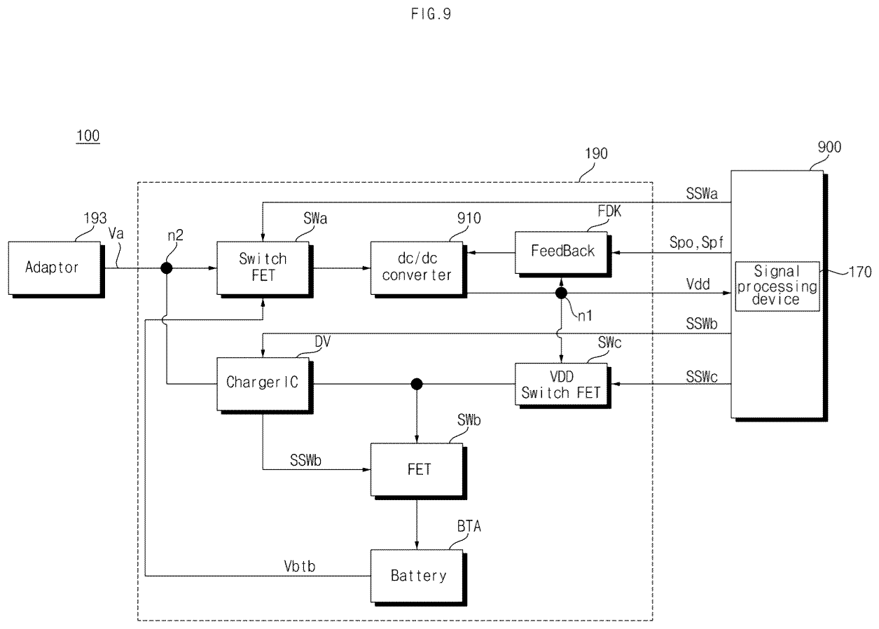

Therefore, the present disclosure proposes a method for efficiently charging the battery BTA. This is described with reference to FIG. 9A or below.

FIG. 9 illustrates one example of an internal circuit diagram of the power supply according to an embodiment of the present disclosure.

The power supply 190 according to an embodiment of the present disclosure includes a converter 910 converting the level of the input voltage Va and outputting the display driving voltage Vdd, a first switch SWb electrically connected to the battery BTA, a driving driver DV controlling driving of the first switch SWb based on the input voltage Va, and a second switch SWc connected between the first switch SWb and the converter 910.

The converter 910 of the power supply 190 may convert inputted first level of input voltage Va and output second level of driving voltage Vdd through an adapter 193.

For example, the converter 910 boosts the first level of input voltage Va to output the driving voltage Vdd at the second level greater than the first level.

Meanwhile, the driving driver DV of the power supply 190 may transfer the inputted first level of input voltage Va or the converted voltage to the first switch SWb through the adapter 193.

The first switch SWb is the charging switch, and only one first switch SWb may be implemented unlike as shown in FIG. 8A.

The second switch SWc is connected between the first switch SWb and the converter 910, and transfers a current based on the driving voltage Vdd to the first switch SWb upon turn-on and does not supply a current to the first switch SWb upon turn-off.

Meanwhile, the power supply 190 may further include a third switch SWa supplying the input voltage Va to the converter 910 based on switching.

That is, the third switch SWa of the power supply 190 may be disposed between the adapter 193 and the converter 910.

The converter 910 may operate by receiving the input voltage Va only when the third switch SWa is turned on. As a result, the converter 910 may be stably driven.

Meanwhile, the third switch SWa and the driving driver DV may be connected to each other in parallel.

In FIG. 9, it is illustrated that the third switch SWa and the driving driver DV are connected to a node n2 in parallel.

Meanwhile, the battery BTA may supply operating voltage Vbtb to the third switch SWa. As a result, the converter 910 may be stably driven.

Meanwhile, the image display apparatus 100 according to an embodiment of the present disclosure includes a display 180 and a power supply 190 supplying voltage to the display 180.

Meanwhile, the image display apparatus 100 according to an embodiment of the present disclosure further includes a mainboard 900 including a signal processing device 170.

The mainboard 900 or the signal processing device 170 may output a display on signal Spo or a display off signal to the power supply 190. As a result, different battery charging paths are used when the display 180 is on and the display 180 is off to efficiently charge the battery BTA.

Meanwhile, the mainboard 900 or the signal processing device 170 may output a driving control signal SSwb to the driving driver DV and output a switch driving control signal SSwc to the second switch SWc. As a result, the driving driver DV and the second switch SWc may be stably driven.

Meanwhile, the mainboard 900 or the signal processing device 170 may output a switch driving control signal SSWa to the third switch SWa. As a result, the third switch SWa may be stably driven.

Meanwhile, the power supply 190 may further include a signal transceiver FDK connected between the converter 910 and the mainboard 900.

The signal transceiver FDK may receive the display on signal Spo or the display off signal Spf from the mainboard 900 including the signal processing device 170 or the signal processing device 170, and transfer the display on signal Spo or the display off signal Spf to the converter 910.

As a result, different battery charging paths are used when the display 180 is on and the display 180 is off to efficiently charge the battery BTA.

Meanwhile, when the second switch SWc is turned off, the driving voltage Vdd outputted from the converter 910 may be supplied to the mainboard 900 via a node n1 between the signal transceiver FDK and the second switch SWc.

Meanwhile, when the second switch SWc is turned on, a current based on the driving voltage Vdd outputted from the converter 910 may be supplied to the first switch SWb via the node n1 between the signal transceiver FDK and the second switch SWc, and the second switch SWc.

As illustrated in FIG. 9, the first switch SWb is electrically connected to the battery BTA, and the second switch SWc is disposed between the first switch SWb and the converter 910 or between the first switch SWb and the signal transceiver FDK to prevent a phenomenon in which heat generation is concentrated even though the first switch SWb and the second switch SWc are simultaneously turned on.

Meanwhile, the converter 910 operates based on the display on signal Spo from the signal transceiver FDK to supply the driving voltage Vdd to the display 180, and may not output the driving voltage Vdd based on the display off signal Spf. As a result, different battery charging paths are used when the display 180 is on and the display 180 is off to efficiently charge the battery BTA.

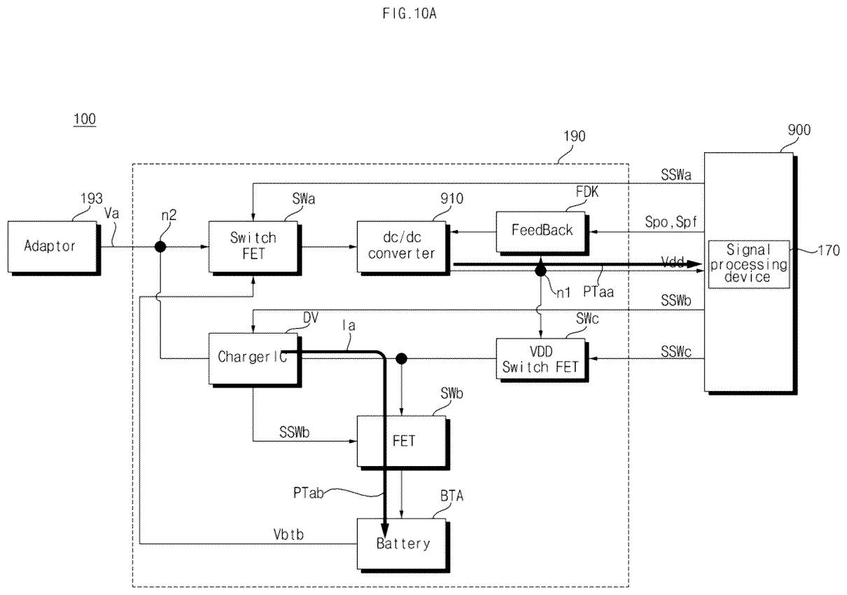

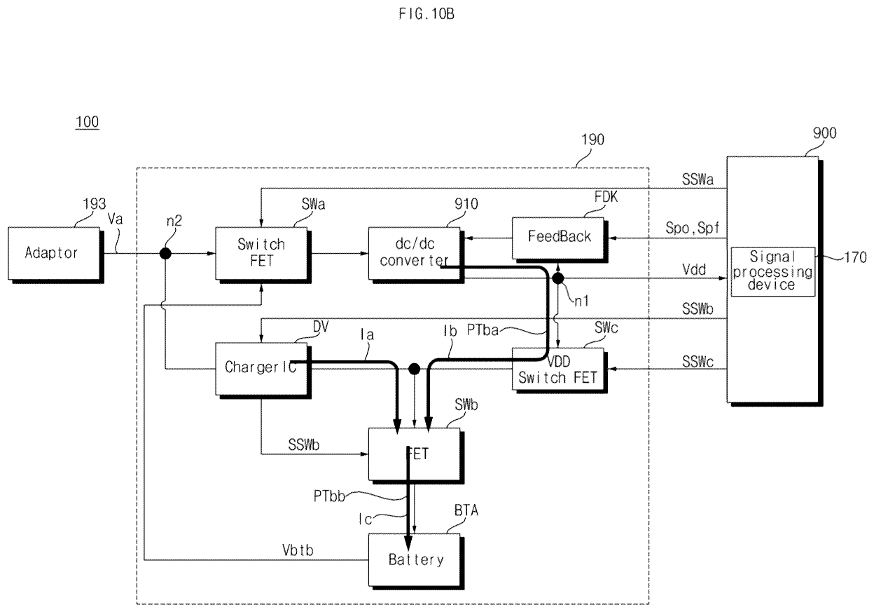

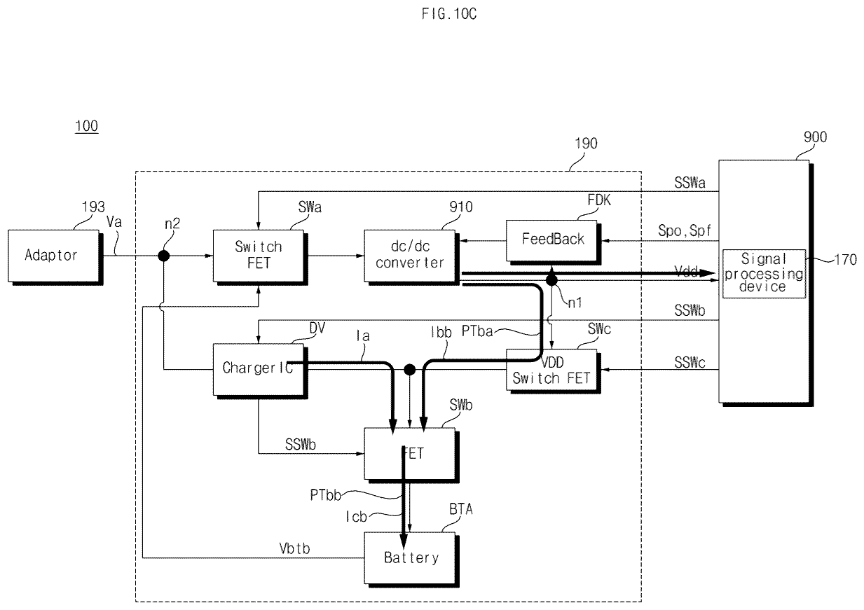

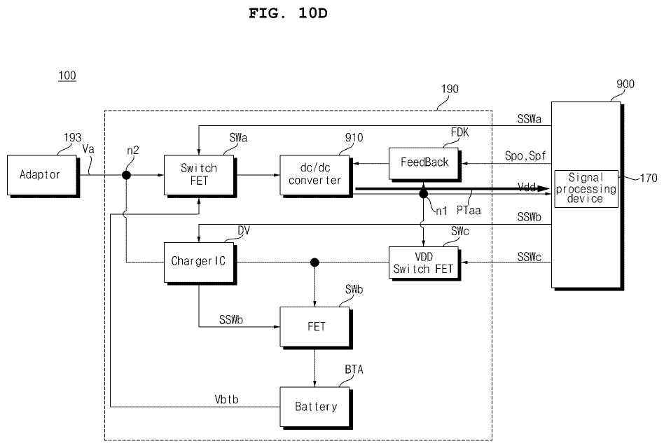

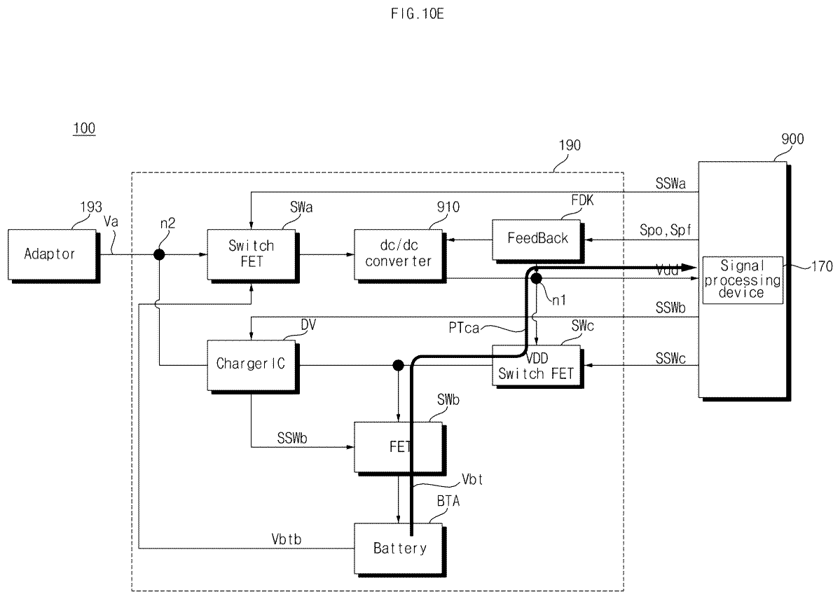

FIGS. 10A to 10E are views referred to for an operation description of FIG. 9.

First, FIG. 10A illustrates one example of a case where the display 180 is turned on while the input voltage is supplied to the image display apparatus 100.

Referring to FIG. 10A, the display 180 is turned on while the input voltage is supplied to the image display apparatus 100, so the predetermined image 710 may be displayed in the display 180, as illustrated in FIG. 7C.

Meanwhile, when the display 180 is turned on upon the charging mode of the battery BTA, the first switch SWb is turned on and the second switch SWc is turned off.

In FIG. 10A, it is illustrated that the driving voltage Vdd outputted from the converter 910 is supplied to the mainboard 900 according to a current path such as PTaa. As a result, the mainboard 900 may consequently output the driving voltage Vdd to the display 180.

Meanwhile, in FIG. 10A, it is illustrated that as the first switch SWb is turned on, the first current Ia is supplied to the battery BTA through the driving driver DV and a current path PTab of the first switch SWb.

As a result, the power supply 190 may supply, to the display 180, the driving voltage outputted from the converter 910, and supply, to the battery BTA, the first current Ia which flows through the driving driver DV.

FIG. 10B illustrates a case of a stand-by mode in which the display 180 is off while the input voltage is supplied to the image display apparatus 100.

Referring to FIG. 10B, when the display 180 is turned off while the input voltage is supplied to the image display apparatus 100, the image may not be displayed in the display 180, but the display 180 may enter the stand-by mode, as illustrated in FIG. 7A.

Meanwhile, when the display 180 is turned off upon the charging mode of the battery BTA, the first switch SWb is turned on and the second switch SWc is turned on.

In FIG. 10B, it is illustrated that the driving voltage Vdd outputted from the converter 910 is supplied to the first switch SWb according to the current path such as PTba.

Meanwhile, as the first switch SWb is turned on, the first current Ia is supplied to the first switch SWb through the driving driver DV and the current path PTab of the first switch SWb.

Meanwhile, as the second switch SWc is turned on, the second current Ib is supplied to the first switch SWb through the current path PTba of the converter 910 and the second switch SWc.

Meanwhile, the level of the second current Ib may be lower than the level of the first current Ia.

Meanwhile, the first switch SWb supplies, to the battery BTA, the third current Ic which is generated by adding the first current Ia which flows through the driving driver DV and the second current Ib which flows through the second switch SWc. As a result, the battery BTA may be efficiently charged in the stand-by mode.

Meanwhile, by comparing FIGS. 10A and 10B, upon the charging mode of the battery BTA, the level of the current inputted into the battery BTA is higher in the stand-by mode in which the display 180 is turned off as in FIG. 10B than when the display 180 is turned on as in FIG. 10A.

Meanwhile, in the charging mode of the battery BTA, a charging speed change rate (C-rate) of the battery BTA is higher in the stand-by mode in which the display 180 is turned off as in FIG. 10B than when the display 180 is turned on as in FIG. 10A. As such, different battery charging paths are used when the display 180 is on and the display 180 is off to efficiently charge the battery BTA.

FIG. 10C illustrates another example of a case where the display 180 is turned on while the input voltage is supplied to the image display apparatus 100.

FIG. 10C is similar to FIG. 10A, but FIG. 10C is different from FIG. 10A in that the second switch SWc is not turned off, but the second switch SWc is on/off-switched or turned on in a state in which the display 180 is on.

Referring to FIG. 10C, the display 180 is turned on while the input voltage is supplied to the image display apparatus 100, so the predetermined image 710 may be displayed in the display 180, as illustrated in FIG. 7C.

Meanwhile, when the display 180 is turned on upon the charging mode of the battery BTA, the first switch SWb may be turned on and the second switch SWc may be on/off-switched or turned on.

It is illustrated that as the first switch SWb is turned on, the first current Ia is supplied to the battery BTA through the driving driver DV and a current path PTab of the first switch SWb.

Meanwhile, the converter 910 supplies the driving voltage Vdd to the display 180. Meanwhile, as the second switch SWc is turned on, a current Ibb which flows through the converter 910 and the second switch SWc may be supplied to the first switch SWb.

Meanwhile, the first switch SWb supplies, to the battery BTA, the current Ich which is generated by adding the first current Ia which flows through the driving driver DV and the current Ibb which flows through the converter 910 and the second switch SWc. As a result, the battery BTA may be efficiently charged in the stand-by mode.

Meanwhile, the aggregated current Icb of FIG. 10C may be smaller than the aggregated third current Ic of FIG. 10B.

FIG. 10D illustrates one example of a case where the input voltage is supplied to the image display apparatus 100, but the display 180 is on while the charging mode is completed.

Referring to FIG. 10D, the input voltage is supplied, but when the charging mode is completed, the battery BTA is not charged any longer, and only the display 180 is turned on.

Meanwhile, when the input voltage Va is supplied, and the display 180 is turned on in a state in which the battery BTA is not in the charging mode, the first switch SWb and the second switch SWc are turned off, and the converter 910 operates.

As a result, the driving voltage Vdd outputted from the converter 910 may be supplied to the display 180.

In FIG. 10D, it is illustrated that the driving voltage Vdd outputted from the converter 910 is supplied to the mainboard 900 according to the current path such as PTaa. As a result, the mainboard 900 may consequently output the driving voltage Vdd to the display 180.

FIG. 10E illustrates a case where the display 180 is on while the input voltage is not supplied to the image display apparatus 100.

Referring to FIG. 10E, when the display 180 is turned on while the input voltage is not supplied to the image display apparatus 100, so the image 520 may be displayed in the display 180, as illustrated in FIG. 7D.

Meanwhile, the battery BTA operates in a discharging mode.

As a result, the first switch SWb and the second switch SWc are turned on, and the converter 910 does not operate.

That is, upon the discharging mode of the battery BTA, the converter may not operate. As a result, the display 180 may be stably operated.

Meanwhile, as the first switch SWb and the second switch SWc are turned on, battery voltage Vbt from the battery BTA may be supplied to the mainboard 900 via the first switch SWb, the second switch SWc, and the node n1. In addition, the mainboard 900 may supply battery voltage Vbt to the display 180.

Meanwhile, a level of the battery voltage Vbt may be equal to or lower than the level of the driving voltage Vdd outputted from the converter 910.

That is, upon the discharging mode of the battery BTA, when the display 180 is turned on, the first switch SWb and the second switch SWc are turned on so as to supply the battery voltage Vbt to the display 180 through a current path which flows through the battery BTA, the first switch SWb, and the second switch SWc. As a result, the display 180 may be stably operated in the discharging mode of the battery BTA.

Meanwhile, in the case of the stand-by mode in which the display 180 is turned off, the driving voltage Vdd outputted from the converter 910 may not be supplied to the display 180. As a result, the battery BTA may be stably charged in the stand-by mode.

Meanwhile, in the charging mode of the battery or a normal mode other than the charging mode, the driving voltage Vdd outputted from the converter 910 may be equal to or greater than the battery voltage Vbt supplied to the display 180 upon the discharging mode of the battery BTA according to the operation of the converter 910. As a result, the display 180 may be stably operated.

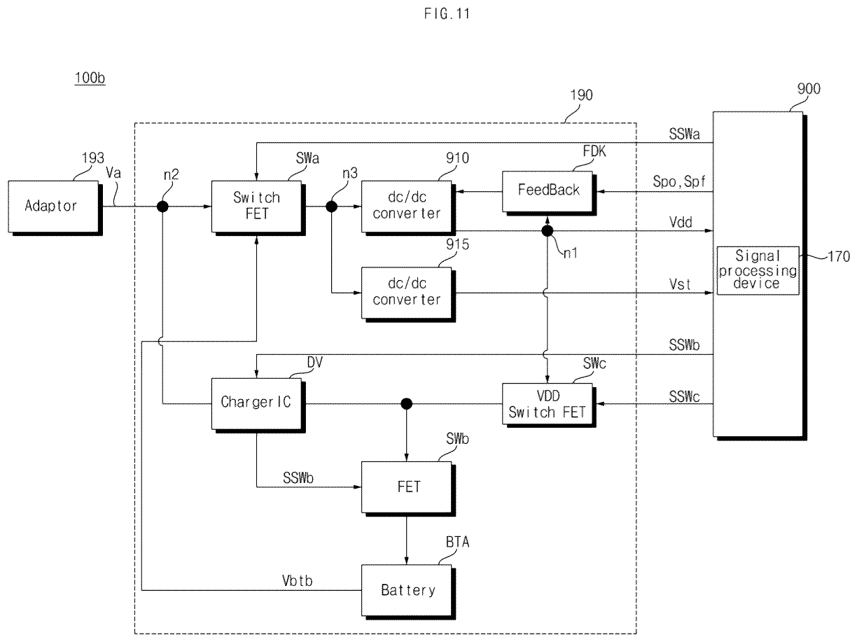

FIG. 11 illustrates one example of an internal circuit diagram of a power supply according to another embodiment of the present disclosure.

Referring to FIG. 10E, a power supply 190b according to another embodiment of the present disclosure is similar to the power supply 190 of FIG. 9, but the power supply 190b is different from the power supply 190 in that the power supply 190b further includes a second converter 915.

The power supply 190b according to another embodiment of the present disclosure includes a converter 910 converting the level of the input voltage Va and outputting the display driving voltage Vdd, a first switch SWb electrically connected to the battery BTA, a driving driver DV controlling driving of the first switch SWb based on the input voltage Va, a second switch SWc connected between the first switch SWb and the converter 910, and a second converter 915 converting the level of the input voltage Va and outputting micom driving voltage Vst at a lower level than the display driving voltage Vdd.

The power supply 190b according to another embodiment of the present disclosure may supply the micom driving voltage Vst to the mainboard 900.

The mainboard 900 may supply the micom driving voltage Vst to a micom (not illustrated) which continuously operates even in the stand-by mode.

As such, the micom driving voltage Vst at the lower level than the display driving voltage Vdd is supplied to the micom (not illustrated) which continuously operates even in the stand-by mode to reduce stand-by power.

Meanwhile, in FIG. 11, it is illustrated that the converter 910 and the second converter 915 are connected to a node n3 in parallel, but unlike this, various modifications can be made.

That is, the second converter 915 is connected to an output terminal of the converter 910 in series and receives the display driving voltage Vdd to output the micom driving voltage Vst which is step-down voltage.

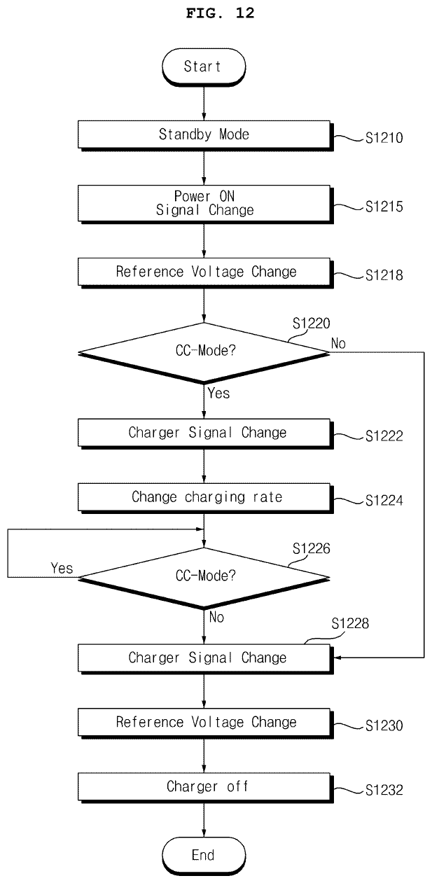

FIG. 12 is a flowchart illustrating an operating method of a power supply according to an embodiment of the present disclosure.

Referring to FIG. 12, a power supply 190 receives a display off signal Spf from a mainboard 900, the power supply 190 enters a stand-by mode (S1210).

Next, the power supply 190 changes an operation of a converter 910 based on the display off signal Spf to turn off the operation of the converter 910 (S1215).

Next, the power supply 190 changes reference voltage (S1218). For example, the reference voltage may be changed from display driving voltage Vdd to battery voltage Vbt.

Next, the power supply 190 checks a charging mode to judge whether the charging mode is a static current mode (S1220).

In addition, when the charging mode corresponds to the static current mode, the power supply 190 turns on a second switch SWc based on a switch driving control signal SSwc in order to perform the charging mode according to a static current operation (S1222).

In addition, the power supply 190 varies a charging rate or a charging speed charge rate based on turn-on of the second switch SWc (S1224).

That is, the power supply 190 performs charging based on the first current as in FIG. 10A, and performs charging based on the third current greater than the first current by turning on the second switch SWc as in FIG. 10B.

Next, the power supply 190 checks the charging mode to judge whether the charging mode is the static current mode again (S1226).

The power supply 190 may control a static voltage mode to be performed after the static current mode.

Meanwhile, the power supply 190 checks the charging mode to perform the charging mode according to a static voltage operation in the case of the static voltage mode.

In addition, the power supply 190 turns off the second switch SWc based on the switch driving control signal SSwc (S1228).

Next, the power supply 190 changes reference voltage (S1230). For example, the reference voltage may be changed from the battery voltage Vbt to the display driving voltage Vdd.

Next, the power supply 190 may turn off the operation of the driving driver DV according to completion of the charging mode (S1232).

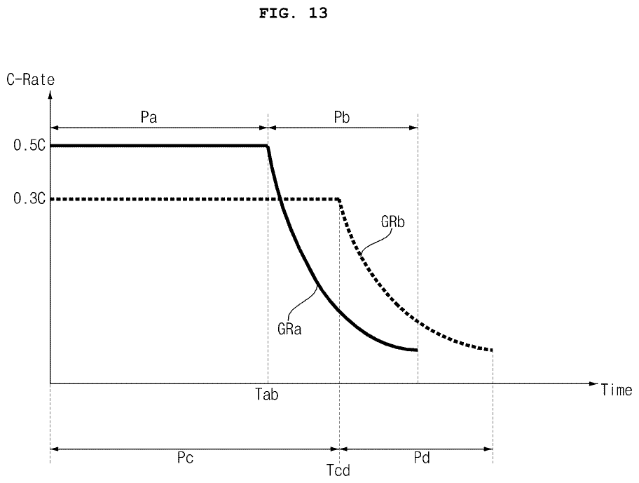

FIG. 13 is a view referred to for describing FIG. 12.

Referring to FIG. 13, when the charging mode of the battery BTA is switched to a stand-by mode in which the display 180 is off as in FIG. 10B in a state in which the display 180 is on as in FIG. 10A, the power supply 190 operates in the static current mode as in a graph of GRa during a first period Pa to supply the third current Ic to the battery BTA through a first switch SWb.

Next, in the charging mode of the battery BTA, in the case of stand-by mode in which when the display 180 is off, the power supply 190 may operate in the static voltage mode as in the graph of GRa during a second period Pb after the first period Pa. As a result, the battery BTA may be efficiently charged in the stand-by mode.

Meanwhile, in the charging mode of the battery BTA, when the display 180 is on as in FIG. 10A, the power supply 190 operates in the static current mode to supply the first current Ia to the battery BTA through the first switch SWb, as in a graph of GRb.

Next, in the charging mode of the battery BTA, when the display 180 is an on state, the power supply 190 may operate in the static voltage mode as in the graph of GRb during a fourth period Pd after the third period Pc.

In this case, the third period Pc may be longer than the first period Pa.

As a result, different battery charging paths are used when the display 180 is on and the display 180 is off to efficiently charge the battery BTA.

Meanwhile, when the graph of GRa and the graph of GRb are compared, the changing change rate in the stand-by mode in which the display 180 is off as in FIG. 10B is 0.5 C and is greater than 0.3 C which is the charging change rate when the display 180 is on as in FIG. 10A.

That is, in the charging mode of the battery BTA, in response to the display switching to the stand-by mode in the state in which the display 180 is on upon the charging mode of the battery, a first charging charge rate may be increased to a second charging charge rate greater than the first charging charge rate with respect to the charging rate from the battery BTA.

As a result, different battery charging paths are used when the display 180 is on and the display 180 is off to efficiently charge the battery BTA.

As described above, a power supply according to an embodiment of the present disclosure includes a converter to convert a level of input voltage and output driving voltage of a display, a first switch electrically connected to a battery, a driving driver to drive the first switch based on the input voltage, and a second switch connected between the first switch and the converter, and supplies a third current generated by adding a first current which flows through the driving driver as the first switch and the second switch are turned on in a stand-by mode in which the display is off upon a charging mode of the battery to the battery through the first switch. As a result, the battery can be efficiently charged in the stand-by mode.

Meanwhile, in response to the display being turned on upon the charging mode of the battery, by turning on the first switch and turning off the second switch, the driving voltage outputted from the converter may be supplied to the display and the first current which flows through the driving driver may be supplied to the battery. As a result, different battery charging paths are used in response to the display being on and the display is off to efficiently charge the battery.

Meanwhile, upon the charging mode of the battery, a charging speed change rate of the battery is preferably greater in the stand-by mode in which the display is turned off than in which the display is turned on. As a result, different battery charging paths are used in response to the display being on and the display is off to efficiently charge the battery.

Meanwhile, in response to the input voltage being supplied and the display being turned on in a state in which the battery is not in the charging mode, the first switch and the second switch are turned off to supply the driving voltage outputted from the converter to the display. As a result, the driving voltage can be stably supplied to the display.

Meanwhile, in the stand-by mode in which the display is turned off, the driving voltage outputted from the converter may not be supplied to the display. As a result, the battery can be efficiently charged in the stand-by mode.

Meanwhile, in response to the display being turned on upon a discharging mode of the battery, by turning on the first switch and the second switch, battery voltage may be supplied to the display through current paths which flow through the battery, and the first and second switches. As a result, the display can be stably operated in the battery discharging mode.

Meanwhile, in the charging mode or a normal mode of the battery, the driving voltage outputted from the converter may be equal to or greater than the battery voltage supplied to the display upon the discharging mode of the battery according to an operation of the converter. Therefore, the display can be stably operated.

Meanwhile, the converter may not operate upon the discharging mode of the battery. As a result, the display can be stably operated.

Meanwhile, the power supply may further include a signal transceiver to receive a display on signal or a display off signal from a mainboard including a signal processing device or the signal processing device, and transmit the display on signal or the display off signal. As a result, different battery charging paths are used in response to the display being on and the display is off to efficiently charge the battery.

Meanwhile, the converter is configured to operate based on the display on signal from the signal transceiver, supply the driving voltage to the display, and not output the driving voltage based on the display off signal from the signal transceiver. As a result, different battery charging paths are used in response to the display being on and the display is off to efficiently charge the battery.

Meanwhile, in response to the display switching from the on state to the stand-by state upon the charging mode of the battery, the converter may be configured to operate in a static current mode during a first period to supply the third current to the battery through the first switch, and operate in a state voltage mode during a second period after the first period. As a result, the battery can be efficiently charged in the stand-by mode.

Meanwhile, in response to the display being on upon the charging mode of the battery, the converter may be configured to operate in the static current mode during a third period to supply the first current to the battery through the first switch, and operate in the state voltage mode during a fourth period after the third period, and the third period may be longer than the first period. As a result, different battery charging paths are used in response to the display being on and the display is off to efficiently charge the battery.

Meanwhile, in response to the display switching to the stand-by mode in the state in which the display is on upon the charging mode of the battery, a first charging charge rate may be increased to a second charging charge rate greater than the first charging charge rate with respect to the charging rate from the battery. As a result, different battery charging paths are used in response to the display being on and the display is off to efficiently charge the battery.

Meanwhile, the power supply may further include a second converter to convert the level of the input voltage and output micom driving voltage at a lower level than the display driving voltage. As a result, a micom can be stably driven.

Meanwhile, the power supply may further include a third switch to supply the input voltage to the converter based on switching. As a result, the converter can be stably driven.

Meanwhile, the battery may supply operating voltage to the third switch. As a result, the converter can be stably driven.

According to an embodiment of the present disclosure, an image display apparatus includes a display and a power supply to supply voltage to the display, the power supply includes a converter to convert a level of input voltage and output driving voltage of the display, a first switch electrically connected to a battery, a driving driver to drive the first switch based on the input voltage, and a second switch connected between the first switch and the converter, and supplies a third current generated by adding a first current which flows through the driving driver as the first switch and the second switch are on to the battery through the first switch in a stand-by mode in which the display is off upon a charging mode of the battery. As a result, the battery can be efficiently charged in the stand-by mode.

Meanwhile, according to an embodiment of the present disclosure, the image display apparatus may further include a mainboard including a signal processing device, and the mainboard or the signal processing device may output a display on signal or a display off signal to the power supply. As a result, different battery charging paths are used in response to the display being on and the display is off to efficiently charge the battery.

Meanwhile, the mainboard or the signal processing device may output a driving control signal to a driving driver, and output a switch driving control signal to the second switch. As a result, the driving driver and the second switch can be stably driven.

Meanwhile, the mainboard or the signal processing device may output the switch driving control signal to the third switch. As a result, the third switch can be stably driven.

While the embodiments of the present disclosure have been illustrated and described above, the present disclosure is not limited to the aforementioned specific embodiments, various modifications may be made by a person with ordinary skill in the technical field to which the present disclosure pertains without departing from the subject matters of the present disclosure that are claimed in the claims, and these modifications should not be appreciated individually from the technical spirit or prospect of the present disclosure.

What is claimed is:

1. A power supply comprising:
a converter configured to convert a level of input voltage, and a level of an output driving voltage to be provided to a display;
a first switch electrically coupled to a battery;
a driver configured to drive the first switch, based on the input voltage; and
a second switch positioned between the first switch and the converter,
wherein the first switch and the second switch are turned on to supply a third current to the battery through the first switch, based on the battery being in a charging mode and the display being in a stand-by mode in which the display is turned off, and
wherein the third current is generated by adding a first current, which flows through the driver, and a second current, which flows through the converter and the second switch.

2. The power supply of claim 1, wherein in response to the display being turned on while the battery is in the charging mode, turning on the first switch and turning off the second switch, which permits the driving voltage outputted from the converter to be supplied to the display, and the first current, which flows through the driver, to be supplied to the battery.

3. The power supply of claim 1, wherein while the battery is in the charging mode, a charging speed change rate of the battery is greater while the display is in the stand-by mode in which the display is turned off, relative to the charging speed change rate of the battery while the display is turned on.

4. The power supply of claim 1, wherein in response to the input voltage being supplied, and the display being turned on while the battery is not in the charging mode, the first switch and the second switch are turned off to supply the driving voltage, outputted from the converter, to the display.

5. The power supply of claim 1, wherein while the display is in the stand-by mode, the driving voltage outputted from the converter is not supplied to the display.

6. The power supply of claim 1, wherein in response to the display being turned on while the battery is in a discharging mode, the first switch and the second switch are turned on, and battery voltage is supplied to the display through current paths which flow through the battery, the first switch and the second switch.

7. The power supply of claim 6, wherein according to an operation of the converter, while the battery is in the charging mode or is in a normal mode, the driving voltage outputted from the converter is equal to or greater than the battery voltage supplied to the display, while the battery is in the discharging mode.

8. The power supply of claim 6, wherein while the battery is in the discharging mode, the converter does not operate.

9. The power supply of claim 1, further comprising:
a signal transceiver configured to receive a display on signal or a display off signal from a mainboard, and transmit the display on signal or the display off signal,
wherein the mainboard includes a signal processing device.

10. The power supply of claim 9, wherein the converter is configured to:
supply the driving voltage to the display, based on the display on signal from the signal transceiver, and
not output the driving voltage, based on the display off signal from the signal transceiver.

11. The power supply of claim 1, wherein in response to the display switching from the on state to the stand-by state while the battery is in the charging mode, the converter is configured to:
operate in a static current mode during a first period to supply the third current to the battery through the first switch; and
operate in a state voltage mode during a second period after the first period.

12. The power supply of claim 1, wherein in response to the display being on while the battery is in the charging mode, the converter is configured to:
operate in a static current mode during a third period to supply the first current to the battery through the first switch; and
operate in a state voltage mode during a fourth period after the third period,
wherein the third period is longer than the first period.

13. The power supply of claim 1, wherein in response to the display switching to the stand-by mode and the battery being in the charging mode, a first charging charge rate is increased to a second charging charge rate greater than the first charging charge rate with respect to a charging rate from the battery.

14. The power supply of claim 1, further comprising:
a second converter configured to convert a level of the input voltage and output micom driving voltage at a lower level than the driving voltage provided to the display.

15. The power supply of claim 1, further comprising:
a third switch configured to supply the input voltage to the converter based on switching,
wherein the battery supplies operating voltage to the third switch.

16. An image display apparatus comprising:
a display; and
a power supply configured to supply voltage to the display,
wherein the power supply includes:
a converter configured to convert a level of input voltage, and a level of an output driving voltage to be provided to a display;
a first switch electrically coupled to a battery;
a driver configured to drive the first switch, based on the input voltage; and
a second switch positioned between the first switch and the converter,
wherein the first switch and the second switch are turned on to supply a third current to the battery through the first switch, based on the battery being in a charging mode and the display being in a stand-by mode in which the display is turned off, and
wherein the third current is generated by adding a first current, which flows through the driver, and a second current, which flows through the converter and the second switch.

17. The image display apparatus of claim 16, further comprising:
a mainboard including a signal processing device,
wherein the mainboard or the signal processing device outputs a display on signal or a display off signal to the power supply.

18. The image display apparatus of claim 16, further comprising:
a mainboard including the signal processing device,
wherein the mainboard or the signal processing device outputs a driving control signal to the driver, and outputs a switch driving control signal to the second switch.

19. The image display apparatus of claim 16, wherein in the power supply apparatus, in response to the display being turned on while the battery is in the charging mode, turning on the first switch and turning off the second switch, which permits the driving voltage outputted from the converter to be supplied to the display, and the first current, which flows through the driver, to be supplied to the battery.

20. The image display apparatus of claim 16, wherein while the battery is in the charging mode, a charging speed change rate of the battery is greater while the display is in the stand-by mode in which the display is turned off, relative to the charging speed change rate of the battery while the display is turned on.
